(19) United States
(12) Patent Application Publication
(10) Pub. No.: US 2011/0274783 A1
(43) Pub. Date: Nov. 10, 2011

(54) FOOD COMPLEX FOR BALANCING MASCULINE ENERGY AND FEMININE ENERGY AND FOR RECOVERING VITAL ENERGY

(76) Inventor: Eui Sung Lee Lee, El Carpio (Cordoba) (ES)

(21) Appl. No.: 13/127,239

(22) PCT Filed: May 13, 2010
(86) PCT No.: PCT/ES2010/000209

§ 371 Date: Jun. 27, 2011

(30) Foreign Application Priority Data
Jun. 19, 2009 (ES) P200901462

(51) Int. Cl. A23L 1/30; A23L 1/10; A21D 2/00; A23L 1/00; A23L 1/16; A21D 13/00; A23C 9/123; A23L 2/39; A23F 3/00; A23L 1/40; A23L 2/02; A23G 4/06; A23C 19/00; C12G 1/00; A23L 1/314; A23L 1/212

(52) U.S. Cl. 426/3; 426/648; 426/615; 426/618; 426/622; 426/89; 426/557; 426/549; 426/583; 426/590; 426/597; 426/589; 426/599; 426/582; 426/592; 426/647

(57) ABSTRACT

Characterized in that the three kinds of food in the main patent are reduced to two: yin foods with vital energy for the woman and yang foods with vital energy for the man by altering the proportions of foods and adding substances of hot plants, that when drinking them, generate internal heat in the human body, such as ginseng and Yin nature ginger, sulfur and Yang nature reishi mushroom and intermediate nature intermediate staghorn. So as the proposed feeding type is suitable for the treatment of general symptoms of disease in males and females as their constitution and to provide heat to the body in both cases the proportion of cereals is increased up to 70-80 per 100, while that of fruits and vegetables is from 5 per 100, meats and fishes from 10-15 per 100, condiments 5-10 per 100 and is added 5 per 100 of hot substances. To prevent side effects of drugs, eliminate toxins and better resist according to their different constitution, the proportions of the intermediate food are altered to give it energy intermediate food nature and the chemicals substances or specific drugs are mixed.

First certificate of addition to the main patent number P 200401645 called “Food complex for balancing the male and female energy and recovering the vital energy”.

The present invention includes improvements and extensions of the main patent referred to a food product made from the mixing certain raw materials with specific properties and characteristics to compensate the yin deficiencies that the male constitution and metabolism has, and yang deficiencies that the female constitution and metabolism has as well as to recover the vital energy both in men and women, so it is a product to be consumed by the man (male), by the women and by both according to their different compositions.

It was based on Taoism and Oriental medicine that deal with the balance between the negative energy and positive energy and intermediate vital energy, that in nature there are two natures, the yin (−) and yang (+), and that women are yin in nature (um) and men yang in nature. This means that in both men and women converge the two energies, yin and yang, but the feminine nature tends to focus more amount of yin energy that yang energy, while the male tends to focus more yang energy that yin. Life is a continuous exchange of energy and the main way by which energy is received is the food, while we must eat several times a day for every day of our lives to recover the energies and balance them, and so as the body can make its metabolism. The balance reside in maintaining the same amount of the two energies, because if it does get more of one than the other appear imbalances that tend to manifest in our behavior and even in our inner life, affecting generally to the weakest part of each person through somatization, anxiety and other symptoms, being manifested in the man which in Taoism is known as symptoms of yin and in the woman as symptoms of yang. It is for this reason that the object of the invention proposed in the main patent lay in balancing these two energies through a nutritive treatment that gives to the man the yin energies that he lacks, and a nutritive treatment that gives to the woman the yang energies that she lacks and a third nutritive treatment that provides both of the vital energy needed to live.

The main patent provided significant advantages to the state of the art, such as: Daily feeding occupies a central place in Oriental medicine for which is common to prescribe different foods for healing of various diseases, and even to feel good. Everyone knows how in acute conditions such as depression or anxiety the patient eats without restraint and often what it does is aggravate the situation. We also know that there are certain foods that incite to the action, while others, on the other hand slow down the hyperactivity impulses that prevent to do properly tasks requiring concentration and attention to detail. It is also known that to most of the women agree to take citric and sour flavors such as orange, lemon, kiwi, chocolate, tea . . . while, to many men disagree these same citric and sour flavors, causing them acidity in the stomach, headache, body weakness, diarrhea . . . However, men feel a special predilection for sweet and spicy flavors such as honey, sugar, garlic, foods that agree to the men, but not to the women, appearing in them constipation, bloating, fattening, sore throat . . . However salty foods such as Serrano ham, cheese and olives agree with both men and women. This is because the constitution of man is different from women and at the same complementary. It is for this reason that in this invention are mixed in the proportions shown below the raw materials that best are adapted to the constitution of the male to balance the energy of women and vice versa so that the above symptoms do not appear, complementing this specific feeding with another common of vital energy to both genders.

Today we can say without doubt that many health problems are due to poor nutrition, and inadequate food that we eat today can cause imbalances when incorporated to the diet. If to that we add that today are spent more energy than before due to the current way of life, a life in which there is more competition than before, in which we are subjected to a higher level of stress, which is why we need not only more energy, but also a more balanced energy. But scientific theories about the feeding of the Western world have always tried on the properties of foods and their calories, without discussing which foods are appropriate for the male and which are appropriate for women. Since the man and woman are constitutionally opposed and complementary, each gender has different needs, the male needs more foods yin in nature (um) than yang in nature to balance their energy, and unlike woman needs more foods yang in nature that yin. It follows another advantage of the present invention that deals with balancing the male energy or yang with female energy or yin, providing yin foods to the diet of male and vice versa in relation to the diet of woman.

The inadequate feeding of today caused by bad eating habits because of the rush, lack of time, be forced to eat out, the comfort of fast food, directly affect the health. Therefore, the product object of the present invention has as advantage helping to balance the inadequate nutrition, in addition to recover the vital energy.

Human body continuously burns energy for their metabolism and stay alive, all physiological process requires an energy expenditure energy to be recovered by means of food, but most of the foods we eat are cooked, losing through cooking mostly of their active ingredients (proteins, vitamins, minerals), which is why despite eating a high volume of foods we still need more amount of energy. However, the food complex is proposed in this patent retains the properties at maximum of each of the raw materials used, since does not use the heat in the making process (temperature from 40 to 80 centigrades), so that another advantage of this invention is that it preserves the energy value of food versus food compounds known in the state of the art.

In the state of the art relative to the main invention were known procedures for obtaining foods with certain characteristics such as those described in documents ES 1199942, ES 2055663 and A3 550606 referring to a cereal-based highly nutritious food compound, a revitalizing food composition and a food complex usable in nutritional supplementation as a means of improving health respectively. However there is no known method or procedure for a specific food complex to balance the energy of males, to balance the energy of women and to provide vital energy to both, as proposed in the present invention, so constitutes a novelty in itself in the state of the art.

Another of the main advantages of the main invention was the comfort of its oral administration or ingestion as the food complex proposed is presented in containers ready to be ingested several times a day with no previous preparation that is required by its form of presentation and packaging, as described below.

The food complex of the main patent was based on raw materials that are grouped around the following basic foods: seeds, vegetables, fruits, herbs, seaweed, meats, fishes and seafoods, condiments and others. Specific foods that will form the characteristics blends of each of the three products, the specific for men, the specific for women and that of vital energy for both are classified into three categories, which are as follows:
A) Foods of yang nature: (acid and bitter flavors)

Bulk Seeds: Adzuki, Oat, Rye, Wheat, Barley, Beans, Green Pea, Flax, Black Sesame, White Sesame, Sorghum, Lentils. Poppy, Apricot, Kamut,

Dried Vegetables: Celery, Chicory, Artichoke, Escarole, Olive,

Dried fruits: Apple, Pineapple, Pistachio, Carob, Pine Nut, Peanut, Hazelnut, Coconut, Cacao, Sunflower seeds, Quince, Apricot, Plum, Cherry, Lemon, Grapefruit, Kiwi, Strawberry, Mango, Cola Nut,

Herbal teas: Maté, Red tea, Malt, Red tea, Black tea, Lemon grass,

Dried Meats, Fishes and Seafoods: Chicken, Hake and Shark Liver. Yolk,

Condiment of Powder Ume (Japanese Plum),

Others: Wheat and oat bran, Vinegar powder, Citric acid, Brewer yeast, Textured protein, Yoghourt powder, Vitamin C,

B) Foods of yin nature (sweet and spicy flavors)

Bulk Seed: Brown rice, Wild rice, Black rice, Sweet glutinous rice, Millet, basmati rice, Buckwheat, Integral couscous, Quinoa, Amaranth, Pearl Barley, Alfalfa Seed, Watercress, Radish and Mustard.

Dried Vegetables: Pumpkin, Spinach, Ginger, Garlic, Yam, Turnip, Tiger nut, Leek, Watercress, Radish, Beet. Sugar cane, papaya, Pumpkin, Zucchini, Chard, Sweet potatoes,

Dried fruit: Peaches, Persimmon, Honeydew, Fig. Date, Raisin, Jojoba,

Kitchen herbs: Mint, Coriander, Anise, Laurel, Parsley, Sage, Thyme, Anise, Fennel. Saffron, Cumin, Oregano, Sage,

Herbal teas: Chamomile, Licorice, Lemon verbena,

Dried Meats, Fishes and Seafoods; Beef, Prawns, Fish, Clams, Oysters, Tuna, Spider crab, Crab,

Condiments: Black pepper, White pepper, Fructose, Chili, Curry, Honey, Molasses, Honey plant, Chili. Cinnamon, Paprika,

Others: Sugar plant, Barley Yeast,

C) Food of intermediate nature (rough and salty flavors)

Bulk seeds: Green soy, Corn, Black soy, Yellow soy. Glucose millet,

Dried Vegetables: Cepe, Potato, Cabbage, Carrot, Mushroom, Bean sprout, Grapeseed,

Dried fruit: Chestnut, Banana, Almond, Acorn, Pumpkin seeds, Eggplant.

Herbal teas: Tea Green and Seaweed Tea,

Dried Meats, Fishes and Seafoods: Squid, Cuttlefish, Octopus, Hake. Ham, fish roes, Mussel, Elver and Eel

Dried cheese,

Seaweed: Kombu, Wakame, Nori, Espageti, Agar Agar, Arame, Hizikia,

Condiments: iodized salt, mine salt.

Others: Bee Pollen, Royal Jelly, Aloe Vera, Spirulina, Soy Lecithin.

The yang food complex to be consumed by men contained the following composition:

Between 30 and 40 per 100 of foods of Class B

50 per 100 of foods of Class C

Between 10 and 20 per 100 of foods of Class A

The yin food complex to be consumed by women contained the following composition:

Between 30 and 40 per 100 of foods of Class A

50 per 100 of foods of Class C

Between 10 and 20 per 100 of foods of Class B

The food complex of vital energy for men and women had the following composition in relation to weight:

Between 5 and 10 per 100 of foods of the Class A

Between 80 and 90 per 100 of foods of the Class C

Between 5 and 10 per 100 of foods of the Class B

The product obtained by the main patent could be bottled in a clear glass jar of 1000 grams of weight, vacuum-packaging the container. Also it could be packed the powder toasted product after preparing, toasting, grinding and mixing or in capsules if we form with the powder the capsules with encapsulating machine or on beads if we knead the powder with honey and water and form the beads with the pearling machine. It is also possible to package the product in packs of noodles after kneading with water and form the pasta of noodles or in bread packaging kneading the product with water, leaving it to ferment, forming the bread or the pasta and baking. Finally in yoghurt by mixing the powder with normal yoghurt, fermenting from 2 to 5 days in a chamber at the right temperature and packed in yogurt cans and stored in cold. It is also possible to ferment the ingredients together for a period of 1 to 12 months in a container and a suitable place to obtain a compound fermented. If the vegetables are subjected to a drying process may be used in teas or soups.

Regardless of each of the presentations in all cases it is a food complex for men and women, both adult and child, intended to nutritional support designed to control malnutrition, balancing the male body, balancing the female body and giving the vital energy, being able to be prepared raw, toasted and in liquid form.

Both the modes of preparation and the relative compositions were given as a non-limiting example, being understood that they were part of the memory those that without altering its essential aspects have no significant differences.

The purpose of the present addition document is based in providing a set of technical improvements in the food complex described in the main patent, making use equally the Yin nature, Yang nature, flavors and the vital energy contained in foods according to the oriental phytology and their healing properties, but it is appropriate to treat one hand man's health problems, other hand women's health problems in addition to provide vital energy to both. It is based on the specific properties and characteristics of certain raw materials to compensate the yin deficiencies that the male constitution and metabolism has, and yang deficiencies that the female constitution and metabolism has as well as to recover the vital energy both in men and women, so it is a product to be consumed by the man (male), by the women and by both according to their different compositions.

This is how the food preparations proposing this addition has been designed after numerous tests to help, as these foods are independent of medical prescription medicines, to that the man or male improves as soon as possible of their diseases, illnesses or deficiencies and the same for the women, without this means to replace medication, although they do help to mitigate the harmful effects thereof in the body and stimulate its healing effects. It could be said that enrich the male and female organism providing them with appropriate caloric energy for one and another to defend themselves and leave as soon as possible its physical prostration.

We know that foods have healing effects, it is said that soy helps to lose weight, the artichoke is good for the liver, saffron for circulation, green tea is tranquilizer, diuretic and antioxidant, seaweeds help to eliminate toxins, slenderize, regulate the cholesterol and sugar and improve constipation, aroma of pine tranquilizes, the aroma of eucalyptus is good for breathing and cold, onion stimulates the appetite and regulates the functions of the stomach, besides being diuretic. And thus we could continue talking about the healing properties of the food that we eat every day, it being common reason for conversation, so always it has known how agree or disagree, certain plants, herbs, seaweeds, spices, teas depending on the circumstances.

It is also known that vitamin C is good for the flu, prevents cancer, it is essential for athletes, as it works to which they are acclimated to the physical effort without compromising performance, that vitamin E helps to maintain body strength, proteins are necessary for growth, calcium is good for bones, aspirin for pain, there are drugs to control blood pressure, burn fats, diuretics, the effects of minerals, fibers, vitamins, substances are known.

According to the philosophy underpinning the oriental medicine, each raw material has its own Yin and Yang nature, and the same medicine gives to both food and their flavors and aromas, curative properties for certain symptoms of some diseases, from there that the prescriptions of oriental phytotherapy to treat diseases have in mind the yin and yang nature of food and their flavors. This is clearly explained in the most important book of oriental medicine called “Ne jing”. It states that when there is a problem of health the best is treat it with food instead of medicines, because food contains the vital energy and because the flavors and aromas also have healing effects. Likewise, the father of Western medicine, Hippocrates, said that the disease which can not be solved with food is an incurable disease.

Knowing that poor nutrition causes weakness in the body and imbalance in the organism, and that the same poor nutrition also causes many other health problems, among which overweight and obesity are outlined, we can say without fear of error that is more secure treating the health problems with the most suitable feeding.

It is the object of the present addition improving the food complex proposed in the main patent. To this end, we have introduced innovations that come to solve problems associated with the disadvantage that in the main patent is related to foods conceive to balance the energy in men, women and give vital energy to both, but they have not been designed to help to cure diseases, improve the organism of the man and woman so as medicines carry out better their effects, to be provided better defenses to the organism of the man, woman and both. Therefore, the characteristics of these foods to alleviate diseases of men, women and both, are adapted to different conditions or illnesses of patients.

The flavors as oriental medicine serve to strengthen organs and viscera of the human body depending on their character. Thus the acidic flavors enhance liver and vesicle, those of bitter character, heart and small intestine, sweet flavors, the pancreas and stomach, those spicy strengthen the lungs and intestines, those salted invigorate the kidneys and bladder, and finally those rough strengthen the solar plexus and body energy. But apart from strengthening organs and viscera according its character, these same flavors have healing effects on that same organs and viscera decreasing with its ingestion the symptoms of diseases affecting these organs or viscera. Finally, when providing vital energy to these organs improve their defenses, its immune system, its ability and control to confront the disease.

So making the most of the Yin, Yang nature, the character of each of the flavors and the vital energy and healing effects contained in the different food complexes that develops this invention, the same propose to prepare various types of foods suitable for treating various man and woman health issues and provide vital energy to both.

Among their advantages outlines that of being this type of natural food and therefore have no side effects, and suitably administered, not only helps to the chemical treatments and medicines exert better their effect on the human body, but also to eliminate faster toxins that remain in the body and avoid the side effects of treatments. Besides the more vital energy has the patient's body the most effect make it the chemical or medicine treatments, so strengthening the body with proper food, object of the present invention, the patient takes advantage to run better and resist better the treatments.

For a better understanding of the above, it is given an example of a chemotherapeutic practicing drug-based therapy to a male with cancer and consequently the strength of his body weakens. Well, with the food object of the present invention, the male patient which we refer resists better, increases in this the effects of chemical treatment, and its organism eliminates toxins more effectively. However, if the patient does not have sufficient body strength, the drug does not do all their effect and side effects may occur.

The advantages of foods for treatment of diseases of the man and woman proposed in the present addition are as follows:
Increase the body's vital energy
Stimulate the effects of natural and chemical substances
The human body is more resistant to treatment
Decrease the pains
Calm down
Enhance the immune system
Balance the man or woman organism
Prevent side effects of substances contrary to its constitution
Eliminate better and more quickly toxins
The recovery of the male or female patient is faster during and after treatment.
It is achieve that each treatment of health gets better results

The improvements, alternatives or variations introduced in the present patent of addition are as follows:

### Addition 1

The three kinds of food in the main patent are reduced to two, incorporating the foods from the intermediate class both the class of foods with yang nature and those with yin nature.

In the main patent there were 3 classes of foods:
1 Yang foods for the man,
2 Yin foods for the woman,
3 Foods to provide vital energy in both sexes.

In the present addition there are only two classes of foods:
yin foods with vital energy for the woman
yang foods with vital energy for the man

The new proportions that this addition incorporates for maintaining the balance of man and woman and providing vital energy are as follows:

Food for the man:

30-40 per 100 of foods Yin in nature

10-20 per 100 of foods Yang in nature

50 per 100 of foods intermediate in nature

Food for the woman:

10-20 per 100 of foods Yin in nature

30-40 per 100 of foods Yang in nature

50 per 100 of foods intermediate in nature.

With this the following advantages are achieved: It is not necessary to offer three types of food, being two sufficient, as the third type, the intermediate was the same for both. It reduces the appearance, packaging, administration and in general the use only for two food preparations.

### Addition 2

With the present addition the proportions of foods to maintain the balance between man and woman and provide vital energy to both proposed in the first addition are altered and hot plant substances are added, so called because when they are had generate heat inside the body human, such as ginseng and ginger Yin in nature, sulfur and reishi mushroom Yang character and staghorn intermediate in nature, in order that the type of feeding of the main patent is suitable for the treatment of general symptoms of disease in males and females according to their constitution, and provide heat to the body of both. Likewise, the proportions of the intermediate food are altered to give it a nature of energy intermediate food, increasing the proportion of cereals up to 70-80 per 100, while that of fruits and vegetables is 5 per 100, meats and fishes from 10-15 per 100, condiments from 5-10 per 100 and 5 per 100 of hot substances is added, as follows:

Food for the treatment of general symptoms of male:

15 per 100 of Yin nature foods

5 per 100 of Yang nature foods

80 per 100 of energy intermediate nature foods

5 per 100 of Yin and intermediate nature hot plant substances

Food for the treatment of general symptoms of female:

5 per 100 of Yin nature foods

15 per 100 of Yang nature foods

80 per 100 of energy intermediate nature foods

5 per 100 of Yang and intermediate nature hot plant substances

Advantages of this second addition are those of providing the ideal food for the man and woman in those times in which both the one and the other show general symptoms of any disease, helping these foods to provide more vital energy and for its body generates more internal heat, both necessary to confront the disease condition according to the different constitution of the man and woman.

### Addition 3

With this addition the proportions of the main patent are altered so that the food for balancing the male and female energy and for recovering the vital energy of those serves to prevent drug side effects, eliminate toxins and generally resist better in cases of male and female patients undergoing medical treatment according to their different constitution. Also the proportions of the food are altered to give it a nature of energy intermediate food as described in the Addition 2, as follows:

Food to prevent drug side effects and eliminate toxins faster for men:

15 per 100 of Yin nature foods

5 per 100 of Yang nature foods

75 per 100 of energy intermediate nature foods

5 per 100 of seaweed, black soy, ginger and ginseng

Food to prevent drug side effects and eliminate toxins faster for women:

5 per 100 of Yin nature foods

15 per 100 of Yang nature foods

75 per 100 of energy intermediate nature foods

5 per 100 of seaweed and black soy

Advantages of this third addition are providing to the ideal food for men and for women proposed in the main patent some characteristics that make it suitable also for those times in which both the man and woman are subjected to drug treatments, helping to prevent these side effects and eliminate toxins faster.

### Addition 4

With this fourth addition the proportions of the main patent are altered so as the food for balancing the male and female energy and recovering the vital energy of that it is also suitable to treat specific diseases and health problems in cases of male and female patients suffering from diseases, according to their constitution, mixing chemical substances or disease-specific drugs. Likewise, the proportions of the intermediate food to give it a nature of energy intermediate food to this type of feeding for the treatment of diseases in which the proportion of cereals is from 50-60 per 100, vegetables and fruits from 15-20 per 100, condiments from 2-3 per 100 and hot substances from 2-3 per 100, as follows:

Food with substances to treat specific problems of disease for male:

15 per 100 of Yin nature foods

5 per 100 of Yang nature foods

80 per 100 of energy intermediate nature foods

5 per 100 of chemical substances or specific drugs.

Food with substances to treat specific problems of disease for female:

5 per 100 of Yin nature foods

15 per 100 of Yang nature foods

80 per 100 of energy intermediate nature foods

5 per 100 of chemical substances or specific drugs.

Among the chemical substances to treat diseases of the man and woman are aspirin, tranquilizers, insulin, substances that decrease blood pressure, chemotherapy substances, substances that dissolve fat, substances that help hair grow.

Advantages of this fourth addition are providing to the ideal foods for the man and woman proposed in the main patent, characteristics that also make it suitable for the treatment of diseases of both man and woman.

### Addition 5

The product obtained by the main patent can be bottled in a clear glass jar of 1000 grams of weight, vacuum-packaging the container. Also it can be packed the powder toasted product after preparing, toasting, grinding and mixing or in capsules if we form with the powder the capsules with encapsulating machine or on beads if we knead the powder with honey and water and form the beads with the pearling machine. It is also possible to package the product in packs of noodles after kneading with water and form the pasta of noodles or in bread packaging kneading the product with water, leaving it to ferment, forming the bread or the pasta and baking. Finally in yoghurt by mixing the powder with normal yoghurt, fermenting from 2 to 5 days in a chamber at the right temperature and packed in yogurt cans and stored in cold. It is also possible to ferment the ingredients together for a period of 1 to 12 months in a container and a suitable place to obtain a compound fermented. If the vegetables are subjected to a drying process may be used in teas or soups.

A preferred embodiment of the invention can be found in the application of one of these compositions, in particular the yang nature to be consumed by men, when mixing the resulting raw powder from the milling of the following foods in weight indicated below:

| | |
|---|---|
| 1. Adzuki | 15 g |
| 2. Oat | 15 g |
| 3. Barley | 15 g |
| 4. Beans | 15 g |
| 5. Green pea | 15 g |
| 6. Black sesame | 15 g |
| 7. Sorghum | 15 g |
| 8. Celery | 15 g |
| 9. Apple | 15 g |
| 10. Pistachio | 15 g |
| 11. Pine kernel | 15 g |
| 12. Peanut | 15 g |
| 13. Hazelnut | 15 g |
| 14. Coconut | 15 g |
| 15. Cacao | 15 g |
| 16. Sunflower seeds | 15 g |
| 17. Apricot | 15 g |
| 18. Plum | 15 g |
| 19. Kola nut | 15 g |
| 20. Citric acid | 15 g |
| 21. Green soy | 15 g |
| 22. Corn | 25 g |
| 23. Yellow soy | 25 g |
| 24. Black soy | 25 g |
| 25. Glucose millet | 25 g |
| 26. Cepe | 25 g |
| 27. Mushroom | 25 g |
| 28. Cabbage | 25 g |
| 29. Carrot | 25 g |
| 30. Banana | 25 g |
| 31. Chestnut | 25 g |
| 32. Almond | 25 g |
| 33. Pumpkin seeds | 25 g |
| 34. Acorn | 25 g |
| 35. Iodized salt | 25 g |
| 36. Cheese | 25 g |
| 37. Hake | 25 g |
| 38. Pollen | 25 g |
| 39. Royal jelly | 25 g |
| 40. Soy lecithin | 25 g |
| 41. Brown rice | 10 g |
| 42. White rice | 10 g |
| 43. Millet | 10 g |
| 44. Buckwheat | 10 g |
| 45. Quinoa | 10 g |
| 46. Amaranth | 10 g |
| 47. Ginger | 10 g |
| 48. Swiss chard | 10 g |
| 49. Garlic | 10 g |
| 50. Tiger nut | 10 g |
| 51. Leek | 10 g |
| 52. Papaya | 10 g |
| 53. Peach | 10 g |
| 54. Fig | 10 g |
| 55. Date | 10 g |
| 56. Raisin | 10 g |
| 57. Brown sugar | 10 g |
| 58. Black pepper | 10 g |
| 59. Fructose | 10 g |
| 60. Cinnamon | 10 g |
| TOTAL | 1000 g |

As it can see the first 20 foods are of yang nature and its percentage within the set is 30%. The following 20 foods are of intermediate nature and constitute 50% of the compound, while the last 20 are of yin nature and mean the 10% of total. This is specifically a product to be consumed by men, to balance the male energy.

1. Food complex for balancing the male and female energy and recovering the vital energy, characterized in that the three kinds of food in the main patent are reduced to two: yin foods with vital energy for the woman and yang foods with vital energy for the man and in that the new proportions that incorporates this addition to maintaining the balance of men and women and provide vital energy are as follows:
Food for the man:
30-40 per 100 of Yin nature foods
10-20 per 100 of Yang nature foods
50 per 100 of intermediate nature foods
Food for the woman:
10-20 per 100 of Yin nature foods
30-40 per 100 of Yang nature foods
50 per 100 of intermediate nature foods.

2. Food complex for balancing the male and female energy and recovering the vital energy, according to the claim 1, characterized in that are added to foods to maintain a balance of men and women and provide vital energy on both proposed in the main patent the following hot plants substances, or heat generating in the human body when ingested: Yin nature ginseng and ginger, sulfur and Yang nature reishi mushroom and intermediate nature staghorn.

3. Food complex for balancing the male and female energy and recovering the vital energy, according to the preceding claims, characterized in that the proportions of the intermediate food are altered to give it a nature of energy intermediate food, increasing the proportion of cereals up to 70-80 per 100, while that of fruits and vegetables is 5 per 100, meat and fish from 10-15 per 100, of the condiments from 5-10 and 5 per 100 of hot substances is added, as follows:
Food for the treatment of general symptoms of male:
15 per 100 of Yin nature foods
5 per 100 of Yang nature foods
80 per 100 of energy intermediate nature foods
5 per 100 of Yin and intermediate nature hot plant substances
Food for the treatment of general symptoms of female:
5 per 100 of Yin nature foods
15 per 100 of Yang nature foods
80 per 100 of energy intermediate nature foods
5 per 100 of Yang and intermediate nature hot plant substances

4. Food complex for balancing the male and female energy and recovering the vital energy, according to the preceding claims, characterized in that the proportions of the main patent are altered on those foods that balance the male and female energy as follows:
Food to prevent drug side effects and eliminate toxins faster for men:
15 per 100 of Yin nature foods
5 per 100 of Yang nature foods
75 per 100 of energy intermediate nature foods
5 per 100 of seaweed, black soy, ginger and ginseng
Food to prevent drug side effects and eliminate toxins faster for women:
5 per 100 of Yin nature foods
15 per 100 of Yang nature foods
75 per 100 of energy intermediate nature foods
5 per 100 of seaweed and black soy.

5. Food complex for balancing the male and female energy and recovering the vital energy, according to the preceding claims, characterized in that the proportions of the main patent in both the food for energy balance in male and the female are altered, being added chemical substances or disease-specific drugs as follows:
Food with substances to treat specific problems of disease for male:
15 per 100 of Yin nature foods
5 per 100 of Yang nature foods
80 per 100 of energy intermediate nature foods
5 per 100 of chemical substances or specific drugs.
Food with substances to treat specific problems of disease for female:
5 per 100 of Yin nature foods
15 per 100 of Yang nature foods
80 per 100 of energy intermediate nature foods
5 per 100 of chemical substances or specific drugs.
Likewise the proportions of intermediate nature foods are altered, in which the proportion of cereals is from 50-60 per 100, vegetables and fruits from 15-20 per 100, the condiments from 2-3 per 100 and hot substances from 2-3 per 100.

6. Food complex for balancing the male and female energy and recovering the vital energy, according to the preceding claims, characterized in that food group of class A contain organoleptic properties between the sour and bitter flavors and smells, those of Class B, properties of sweet and spicy flavor and smell, and those of intermediate nature present organoleptic properties between rough and salty flavors and raw and salty flavors.

7. Complex food for balancing the masculine and feminine energy and recovering the vital energy, according to the preceding claims, characterized by being present as raw or toasted flour.

8. Complex food for balancing the masculine and feminine energy and recovering the vital energy, according to the preceding claims, characterized by being present as capsules.

9. Complex food for balancing the masculine and feminine energy and recovering the vital energy, according to the preceding claims, characterized by being present pearls.

10. Complex food for balancing the masculine and feminine energy and recovering the vital energy, according to the preceding claims, characterized by being present as pasta noodles or other types of pasta.

11. Complex food for balancing the masculine and feminine energy and recovering the vital energy, according to the preceding claims, characterized by being present as bread.

12. Complex food for balancing the masculine and feminine energy and recovering the vital energy, according to the preceding claims, characterized by being present as yoghurt.

13. Complex food for balancing the masculine and feminine energy and recovering the vital energy, according to the preceding claims, characterized by being present as a powder container mixed with liquid.

14. Complex food for balancing the masculine and feminine energy and recovering the vital energy, according to the preceding claims, characterized by being present as fermented compound.

15. Complex food for balancing the masculine and feminine energy and recovering the vital energy, according to the preceding claims, characterized by being present all the vegetable components dehydrated for being used in teas.

16. Complex food for balancing the masculine and feminine energy and recovering the vital energy, according to the preceding claims, characterized by being present as envelopes with all the components dehydrated to be used in soups.

17. Complex food for balancing the masculine and feminine energy and recovering the vital energy, according to the preceding claims, characterized by being present as granules, cakes, noodles, vegetable juices, teas, soft drinks, fermented beverages, prepared soups, vegetable milks, muesli for breakfast, cookies, candies, food condiments, sauces, desserts, chewing gums, ice creams, prepared salads, precooked meals, meal replacements, canary gofio, sandwiches, hamburgers, pizza, cheeses, tofu, wines and liquors.
